(19) United States
(12) Patent Application Publication
(10) Pub. No.: US 2024/0120698 A1
(43) Pub. Date: Apr. 11, 2024

(54) SYSTEM AND METHOD FOR GENERATING A LIGHT PULSE WITH SUB-PICOSECOND DURATION THAT IS DURATION AND/OR REPETITION FREQUENCY ADJUSTABLE

(71) Applicant: IRISIOME, PESSAC (FR)

(72) Inventors: Romain ROYON, DAX (FR); William RENARD, CESTAS (FR)

(21) Appl. No.: 18/546,147

(22) PCT Filed: Feb. 11, 2022
(86) PCT No.: PCT/EP2022/053409

§ 371 Date: Nov. 22, 2023

(30) Foreign Application Priority Data
Feb. 12, 2021 (FR) 2101376

(51) Int. Cl. H01S 3/00; H01S 3/067; H01S 3/30

(52) U.S. Cl. CPC H01S 3/0057; H01S 3/0085; H01S 3/0092; H01S 3/0675; H01S 3/06754; H01S 3/302; H01S 3/1603

(57) ABSTRACT

A light pulse generation system includes a source, an electro-optical modulator adapted to receive the source laser radiation and to form at least one source light pulse having a duration of less than or equal to 100 picoseconds and to adjust the source light pulse in duration and/or in repetition frequency; an optical amplifier operating in the abnormal dispersion regime to form an amplified light pulse, a passive optical fiber arranged to receive the amplified light pulse and generate a spectrally broadened amplified light pulse, the amplified light pulse having a peak power greater than a determined threshold to spectrally broaden the amplified light pulse by phase self-modulation in the passive optical fiber and to generate a non-linear Raman signal, the non-linear Raman signal being adapted to stabilize in energy the spectrally broadened amplified light pulse.

### CROSS-REFERENCE TO RELATED APPLICATIONS

This application is the US national stage of PCT/EP2022/053409, filed Feb. 11, 2022 and designating the United States, which claims the priority of FR FR2101376, filed Feb. 12, 2021. The entire contents of each foregoing application are incorporated herein by reference.

### TECHNICAL FIELD

The present invention relates to the technical field of devices and methods for generating short light pulses with a duration of between 1 and 10 picoseconds or ultra-short light pulses with a duration of less than 1 picosecond.

The use of light pulses having a duration in the range between one and a several hundreds femtoseconds (fs) or from one to some ten picoseconds finds numerous applications in the scientific, industrial or medical field.

### PRIOR ART

In the above field, it is known to generate short or ultra-short light pulses by various techniques.

The main technique used to obtain short or ultra-short light pulses (femtosecond or picosecond) is based on a mode locking process in a laser cavity. The locking of the oscillating longitudinal modes in the laser cavity requires not only synchronization but also phase matching between a large number of longitudinal modes. In practice, the mode locking technique remains complex. In particular, there are active or passive mode locking methods.

Active mode locking is based on the use of an acousto-optical or electro-optical modulator in the laser cavity, to produce an active modulation of the optical losses of the laser cavity. However, active mode locking requires the use of an external power supply. In addition, the duration of the light pulses generated by active mode locking is of the order of several tens or even hundreds of picoseconds.

Passive mode locking relies on the exploitation of nonlinear optical effects to generate pulses without the need for an external optical modulator. There are several methods based on the variation of the optical losses of a saturable absorbing medium as a function of the light intensity. Mention may be made of nonlinear semiconductor mirrors (SESAM), nonlinear optical loop mirrors (NOLM), nonlinear amplifying loop mirrors (NALM) or nonlinear rotation of the polarization (RNLP). These passive techniques are preferred over active techniques because they do not require an external power supply.

Nevertheless, all these methods operate in a field of well-defined parameters in terms of wavelength, pulse duration or even repetition frequency.

To date, the known methods of active or passive mode locking have major drawbacks for an agile laser system, that is to say adjustable, preferably from one pulse to another, in wavelength, in pulse duration and/or in repetition rate.

Indeed, the SESAM technology makes it possible to design and produce a variety of elements whose operation is individually adapted to each of the wavelengths of the emission spectrum. However, it is not possible to use a single SESAM component over a wide range of wavelength adjustments. The same is true for the NALM technology, the operation of which is based on the gain and the total dispersion of the cavity. In addition, the degrees of freedom to obtain passive mode locking are extremely reduced and require a high level of mastery of this technology. Finally, RNLP technology uses massive components in free space such as phase plates. Since these components are not available in fiber technology, their use involves propagation of the light beam in free space. It is therefore not possible to produce monolithic laser sources with this technology. Moreover, a variation of the birefringence of the fiber by thermal or mechanical effect degrades the locking of the modes. It is then necessary to frequently readjust the orientation of the phase plates to once again obtain a train of stable pulses.

Furthermore, these systems remain intrinsically fixed at the level of the rate or repetition frequency and the duration of the pulses delivered because they are directly associated and imposed by the characteristics of the laser cavities and the amplifying media.

Document US 2004/0240037 A1 describes a source of variable repetition frequency for ultra-fast high-energy lasers. Document U.S. Pat. No. 10,862,263 describes a femtosecond laser source.

However, there is a need for a system and method for generating light pulses of short or ultra-short duration which is also agile, that is to say adjustable, preferably from one pulse to another, in wavelength, in pulse duration and/or in repetition frequency.

There is a need for an agile laser system generating light pulses of short or ultra-short duration, which is robust and stable and preferably monolithic.

### DISCLOSURE OF THE INVENTION

To this end, the present disclosure proposes a system for generating at least one light pulse adjustable in duration and/or in repetition frequency.

More specifically, the invention relates to a system for generating at least one light pulse, said at least one light pulse being adjustable in duration and/or in repetition frequency, the system comprising a source of source laser radiation, an electro-optical modulator, the electro-optical modulator being adapted to receive the source laser radiation and to form at least one source light pulse having a duration of less than or equal to 100 picoseconds, the electro-optical modulator being adapted to adjust said at least one source light pulse in duration and/or in repetition frequency; an optical amplification system comprising an optical amplifier operating in the abnormal dispersion regime, the optical amplification system being adapted to receive said at least one source light pulse and to format least one amplified light pulse, a passive optical fiber arranged to receive said at least one amplified light pulse and generate at least one spectrally broadened amplified light pulse, the amplified light pulse having a peak power greater than a determined threshold to spectrally broaden said at least one amplified light pulse by self-phase modulation in the passive optical fiber and to generate a non-linear Raman signal, the non-linear Raman signal being adapted to stabilize in energy said at least one spectrally broadened amplified light pulse and a compressor arranged to receive at least one spectrally broadened amplified light pulse and to generate at least one compressed pulse, adjustable in duration and/or in repetition frequency by means of the electro-optical modulator.

The system makes it possible to generate at least one light pulse of sub-picosecond duration, adjustable in duration and/or in repetition frequency by electronic means while having a stable energy, from one pulse to another.

According to a particular aspect, the electro-optical modulator is adapted to form a packet of N source light pulses, N being an integer between 100 and 10000, the packet being repeated at a frequency between 1 MHz and 100 MHz.

According to a particular and advantageous embodiment, the optical amplification system comprises a Bragg grating fiber forming a spectrally selective mirror, the Bragg grating fiber being arranged to receive at least one light pulse amplified a first time by the optical amplifier and to return said amplified light pulse to the optical amplifier for a second amplification.

In one embodiment, the passive optical fiber is arranged between the optical amplifier and the Bragg grating fiber.

In another embodiment, the optical amplifier is arranged between the passive optical fiber and the Bragg grating fiber.

According to yet another embodiment, another passive optical fiber is arranged between the optical amplifier and the Bragg grating fiber.

In a particularly advantageous manner, the optical amplifier comprises an optical fiber amplifier doped with erbium, ytterbium, thulium, holmium or neodymium and/or an amplifier with crystals or glass doped with ytterbium or neodymium.

Advantageously, the passive optical fiber is based on silica glass or fluoride glass.

According to a particular aspect, the system for generating at least one light pulse comprises an electric generator adapted to apply a modulated electric signal to the electro-optical modulator, the modulated electric signal being adapted to temporally shape said at least one source light pulse.

In a particular embodiment, the electro-optical modulator is a Mach-Zehnder type amplitude modulator, the system for generating at least one light pulse of sub-picosecond duration comprising a feedback loop servo system of the electro-optical modulator.

The invention also relates to a method for generating at least one light pulse of sub-picosecond duration, said at least one light pulse being adjustable in duration and/or in repetition frequency, the method comprising the following steps: generation of a source laser radiation, modulation of the source laser radiation by means of an electro-optical modulator adapted to form at least one source light pulse and to adjust said at least one source light pulse in duration and/or in repetition frequency; optical amplification of said at least one source light pulse in an optical amplifier operating in the abnormal dispersion regime, to form at least one amplified light pulse; transmission of said at least one amplified light pulse (40) in a passive optical fiber, the amplified light pulse having a peak power greater than a determined threshold to generate at least one amplified light pulse spectrally broadened by self-phase modulation and to simultaneously generate a non-linear Raman signal, and compression of said at least one spectrally broadened amplified light pulse to generate at least one compressed pulse, adjustable in duration and/or in repetition frequency by means of the electro-optical modulator.

Of course, the different characteristics, variants and embodiments of the invention can be associated with each other in various combinations insofar as they are not incompatible or exclusive of each other.

The present disclosure also proposes a method for generating at least one light pulse of sub-picosecond duration adjustable in duration and/or in repetition frequency.

### BRIEF DESCRIPTION OF THE DRAWINGS

In addition, various other characteristics of the invention emerge from the appended description made with reference to the drawings which illustrate non-limiting forms of embodiment of the invention and where:

FIG. 1 is a view according to a first embodiment, based on a double-pass fiber optic amplifier system and a non-linear optical module at the output of the amplifier system;

FIG. 2 is a view according to a second embodiment, based on a double-pass fiber optic amplifier system and a non-linear optical module placed between the fiber optic amplifier and a fiber optic Bragg grating spectral mirror;

FIG. 3 is a view according to a variant of the second embodiment, based on a double-pass fiber optic amplifier system and a fiber optic spectral mirror with Bragg grating and in which the fiber optic amplifier is arranged between two non-linear optical modules;

FIG. 4 is a view according to a variant combining the first and the second embodiment, based on a double-pass optical fiber amplifier system, and the optical fiber amplifier being arranged between a non-linear optical module and a spectral mirror with Bragg grating fiber;

FIG. 5 shows spectral measurements of output light power as a function of wavelength for different input light powers, and illustrates the appearance of Raman peaks as a function of the input light power;

FIG. 6 shows spectral measurements of output light power as a function of the wavelength for different input light powers, and illustrates the effect of bandwidth widening by self-phase modulation and a stabilization effect of the spectral bandwidth beyond a certain input light power;

FIG. 7 is a view according to a variant of the first embodiment, based on a single-pass optical fiber amplifier system and a non-linear optical module at the output of the amplifier system.

It should be noted that in these figures the structural and/or functional elements common to the different variants may have the same reference signs.

### DETAILED DESCRIPTION

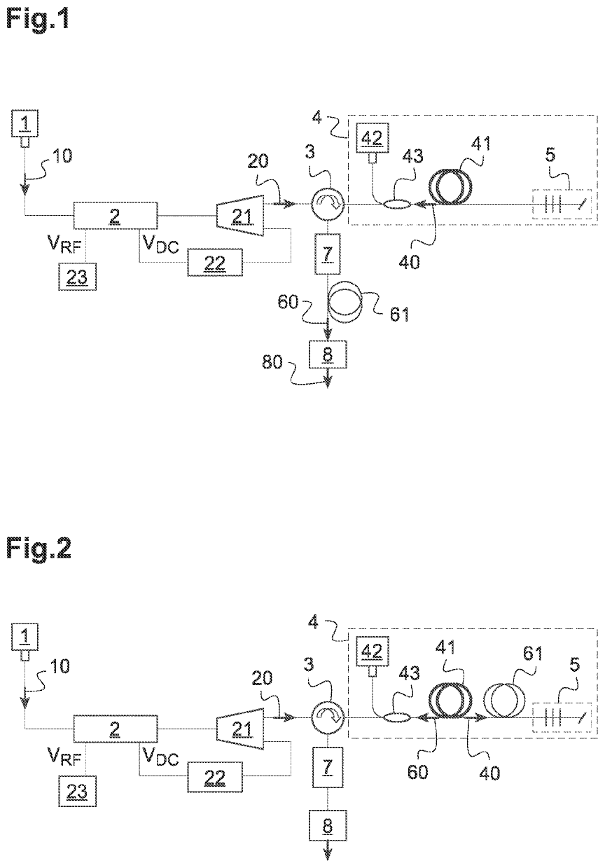

FIG. 1 schematically shows a system for generating a light pulse of sub-picosecond duration according to a first embodiment. The system comprises a source 1, also called laser source or signal source, an electro-optical modulator 2, an optical amplification system 4, a passive optical fiber 61 arranged here at the output of the optical amplification system 4 and a compressor 8.

Source 1 emits source laser radiation 10. Source 1 generally emits at a single signal wavelength. Advantageously, the signal wavelength is tunable on the emission band of a conventional doped fiber. Particularly advantageously, source 1 has a fiber output. The source 1 is adjustable in emission wavelength in a spectral range adapted according to the bandwidth of the optical amplification system 4. For example, the laser source 1 is continuously tunable in wavelength in a spectral range extending from 974 nm to 1200 nm, for use with an optical fiber amplifier based on ytterbium doped fiber. Alternatively or additionally, the laser source 1 is continuously tunable in wavelength in a spectral range around 1550 nm, for example between 1530 and 1630 nm, for use with an optical fiber amplifier based on erbium-doped fiber. Alternatively or additionally, the laser source 1 is continuously tunable in wavelength in a spectral range around 2000 nm, for example between 1930 nm and 2030 nm, for use with an optical fiber amplifier based on thulium-doped fiber. Alternatively or additionally, the laser source 1 is continuously tunable in wavelength in a spectral range around 2100 nm, for use with an optical fiber amplifier based on holmium-doped fiber. Alternatively or additionally, the laser source 1 is continuously tunable in wavelength in a spectral range around 900 nm, for use with an optical fiber amplifier based on neodymium-doped fiber. In the case of a neodymium (Nd:YAG) or erbium (Er:YAG) doped yttrium and aluminum garnet amplifier, the laser source 1 is continuously tunable in wavelength in a spectral range of Nd:YAG, respectively Er:YAG.

As a variant, a source 1 is used which emits radiation at a plurality of discrete wavelengths, on at least one of the spectral ranges indicated above, depending on the fiber optic amplifier used. The discrete wavelengths are generally spaced apart in optical frequency, and the source radiation 10 has a spectral width between 10 kHz up to 300 GHz.

The electro-optical modulator 2 is connected to an electric pulse generator 23 adapted to temporally modulate the light radiation. The electro-optical modulator 2 is for example an electro-optical amplitude modulator (EOM) of the Mach-Zehnder type. The electro-optical modulator has a bandwidth comprised between 5 GHz and 100 GHz. The electro-optical modulator 2 receives the source laser radiation 10. The electric pulse generator 23 delivers an electric signal comprising at least one electric pulse of a duration comprised between 10 ps and 10 ns. A signal generator of the clock type, low frequency generator or synthesizer makes it possible to control the recurrence of the electrical pulses. The electrical signal is applied to at least one electrode of the electro-optical modulator 2 to temporally modulate the amplitude of the light radiation and form a modulated light radiation comprising at least one source light pulse 20 at the output of the electro-optical modulator 2. For example the source laser radiation being continuous in time, the electro-optical modulator 2 cuts out at least one source light pulse 20 of a duration less than or equal to 100 picoseconds at the signal wavelength.

The electric generator is configured so as to generate an electric pulse on demand, a train of electric pulses with a repetition frequency comprised between 1 kHz and 40 GHz. For example, if a repetition frequency of 20 GHz is used, the duration of the electric pulse is 40 ps. According to a particularly advantageous variant, the electric generator is configured to produce a signal in the form of packets of electric pulses. Each packet of electric pulses comprises a number N of pulses, where N is an integer between 100 and 10000. The packets of electric pulses are emitted periodically with a repetition frequency between packets comprised between 1 MHz and 20 GHz. For this purpose, the electrical signal comprises a carrier wave, consisting of a periodic signal at the repetition frequency between packets, of generally sinusoidal shape. The carrier wave is modulated by another periodic input signal at another frequency comprised between 1 Hz and 1 MHz square, which can be square, sinusoidal, triangular or otherwise.

The electrical input signal can also be programmed to obtain pre-recorded shapes. Alternatively, the electrical input signal is adjusted during use of the light pulse generation system in order to adapt to the needs of the application considered. This type of operation is particularly useful for applications which require real-time adjustment of the duration and/or of the repetition rate of the light pulses and thus allow processes or treatments to evolve over time.

The electrical input signal is then shaped to generate electrical pulses of 10 ps to 10 ns duration at the carrier wave repetition rate.

The shaped electrical signal is applied to the electrodes of the electro-optical modulator 2. To ensure the best signal-to-noise ratio, corresponding to the extinction level of the modulator, a feedback loop is applied to the electro-optical modulator 2. An optical coupler 21 placed at the output of the electro-optical modulator 2 and a bias controller 22 which applies a feedback signal to the electro-optical modulator 2, are used. The optical coupler 21 allows, on one channel, one part (for example 99%) of the modulated light radiation to pass in the direction of the optical amplification system 4. The optical coupler 21 picks up, on another channel, another part (for example 1%) of the modulated light radiation. The bias controller 22 analyzes the extinction level at the output of the electro-optical modulator and adapts a bias voltage as a function of the measured extinction rate. The bias voltage is applied to the terminals of the electro-optical modulator 2. Generally, the measured extinction rate remains at values of the order of 30 dB. However, the extinction rate can vary over time between 20 dB and 40 dB particularly due to thermal variations. The feedback loop makes it possible to stabilize the extinction rate of the electro-optical modulator 2 and thus contributes to stabilizing the energy of the light pulses.

At the output of the electro-optical modulator 2, the modulated light radiation comprising at least one source light pulse 20 at the signal wavelength is transmitted in the direction of the optical amplification system 4.

The optical amplification system 4 comprises one or more amplification stages. Advantageously, the optical amplification system 4 is based on the use of one or more amplifiers based on doped optical fiber (Yb, Er, Tm, Nd) or in crystal/glass amplifiers (Nd:YAG, Er:YAG, etc.).

In the first exemplary embodiment illustrated in FIG. 1, the optical amplification system 4 comprises an amplifier 41 with doped optical fiber. The optical fiber amplifier 41 is here used in double pass. More precisely, the optical amplification system 4 comprises an optical circulator 3, a pump 42, a pump-signal combiner 43, the optical fiber amplifier 41 and a Bragg grating optical fiber 5 forming a spectrally selective mirror. The optical circulator 3 is arranged at the output of the electro-optical modulator 2. When a feedback loop device is used to stabilize the electro-optical modulator 2, as described above, the optical circulator 3 is arranged at the output of the optical coupler 21. The optical fiber amplifier 41 is placed between the optical circulator 3 and the Bragg grating optical fiber 5. The pump-signal combiner 43 is arranged at one end of the optical fiber amplifier 41, according to the pumping scheme used. In the example illustrated in FIG. 1, the pump-signal combiner 43 is arranged between the optical circulator 3 and the optical fiber amplifier 41. The pump 42 generates a pump signal at a pump wavelength which is transmitted to the optical fiber amplifier 41 via the pump-signal combiner 43. The pump wavelength is for example 790 nm, 915 nm, 976 nm or 1470 nm depending on the amplifying medium. Simultaneously, the optical circulator 3 receives the modulated light radiation coming from the electro-optical modulator 2 and transmits it to the pump-signal combiner 43. The pump-signal combiner 43 transmits the modulated light radiation comprising at least one source light pulse 20 to the optical fiber amplifier 41 which amplifies this source light pulse 20 for the first time during a first passage through the optical fiber amplifier 41, in other words in the forward direction. The light pulse amplified a first time, is incident on the Bragg grating optical fiber 5, which spectrally filters the noise generated by amplified spontaneous emission in the amplifier and reflects the light pulse amplified a first time around the length of signal wave and filtered in the direction of the optical fiber amplifier 41. The optical fiber amplifier 41 amplifies this once amplified and filtered light pulse a second time during a second pass through the optical fiber amplifier 41, otherwise said in the return direction, to form at least one amplified light pulse 40 at the signal wavelength with a bandwidth for example of the order of 1 nm. At the output of the optical amplification system 4, the optical circulator 3 receives said at least one amplified light pulse 40 and transmits it in the direction of an output channel in the direction of an optical isolator 7. More generally, between two amplification stages, the optical amplification system 4 advantageously comprises one or more fixed or tunable optical filters in wavelength, and synchronized with each other, these optical filters being suitable for suppressing the amplified spontaneous emission generated in these amplifiers.

The optical amplification system 4 is chosen to operate in an abnormal dispersion regime. Specifically, the optical fiber amplifier 41 has abnormal dispersion.

The system for generating at least one light pulse of sub-picosecond duration comprises a passive optical fiber 61 arranged to receive said at least one amplified light pulse 40 at the output of the optical isolator 7. The passive optical fiber 61 is for example a polarization-maintaining optical fiber based on silica or fluorinated glass of the step-index fiber or photonic crystal fiber (PCF) type. The passive optical fiber 61 is here configured to broaden the spectrum of the amplified light pulse 40 by implementing non-linear optical effects such as self-phase modulation (SPM). Indeed, the SPM results in a spectral broadening of the amplified light pulse 40. This spectral broadening effect induced by SPM results from the variation of the accumulated phase of an electromagnetic field during its propagation in a fiber passive. The SPM thus induces changes in the temporal envelope of the amplified pulse without modifying its amplitude. In the frequency domain, the SPM results in a spreading of the spectrum of the amplified pulse around the signal wavelength, since this is the derivative of the non-linear phase shift. The self-phase modulation has the effect of shifting the low frequency components of the spectrum towards the front of the pulse and the high frequency components of the spectrum towards the tail of the pulse. This SPM effect is the inverse of the dispersion effects in anomalous regime. The mutual compensation of these two effects in the anomalous dispersion regime allows the formation of solitons at the end of the chain, that is to say stationary pulses whose profile does not vary over time and propagation.

The compressor 8 is arranged downstream of the passive optical fiber 61. The compressor 8 thus receives an amplified pulse spectrally broadened by SPM and produces a compressed pulse 80. The electro-optical modulator 2 easily makes it possible to adjust the compressed pulse 80 in duration and/or in repetition frequency.

We will describe in more detail the operating mode of the optical amplification system combined with the passive optical fiber 61, to make it possible to obtain at the output of the compressor 8, a compressed pulse 80 adjustable in duration and/or in frequency, while having a stable energy.

Indeed, it is observed here that the desired spectral broadening comes mainly from the phase self-modulation during the propagation of the amplified pulse in the passive optical fiber 61 and therefore from the non-linear optical index of the silica or the fluoride glass. This non-linear optical effect depends on the peak power of the amplified pulse 40. A variation in the peak power of the amplified pulse 40 generally results in a modification of the broadened spectrum at the output of the passive optical fiber 61. Consequently, a variation in width of the spectrum of the pulse at the input of the compressor 8 is capable of causing a variation in the duration of the compressed pulse. As described above, the electro-optical modulator 2 generates the modulated light radiation comprising at least one source light pulse 20 around the signal wavelength from a source laser radiation 10. However, the electro-optical modulator 2 of the Mach-Zehnder interferometer type has an extinction rate which depends on the effectiveness of constructive and destructive interference. This rate of extinction is brought to vary according to the environmental conditions and in particular of the ambient thermal variations. A Mach-Zehnder interferometer is very complex to stabilize.

The source laser radiation may be temporally continuous. Alternatively, the source laser radiation comprises pulses.

The present disclosure proposes an operating regime of the optical amplification system 4 and of the passive optical fiber 61 which uses the combination of the SPM and a non-linear Raman effect generated in the passive optical fiber 61.

More precisely, we place ourselves in an operating regime of the electro-optical modulator, of the optical amplification system 4 and of the passive optical fiber 61 adapted to generate by spontaneous Raman effect new wavelengths in the spectrum of the amplified pulse. For this, it is necessary that the peak power of the amplified pulse be greater than a spontaneous Raman effect generation threshold in the passive optical fiber 61. However, we are in a regime where the maximum energy remains in the spectral band broadened by SPM around the signal wavelength and is not transferred mainly in the Raman line(s). Moreover, the Raman lines are spectrally shifted with respect to the signal wavelength and lie outside the spectral band broadened by SPM around the signal wavelength. The length of the passive optical fiber is chosen and the input power is adjusted so that each Raman line has a power lower than that of the pulse amplified around the signal wavelength and broadened by SPM. This compromise makes it possible to maintain a constant energy in each amplified pulse around the signal wavelength.

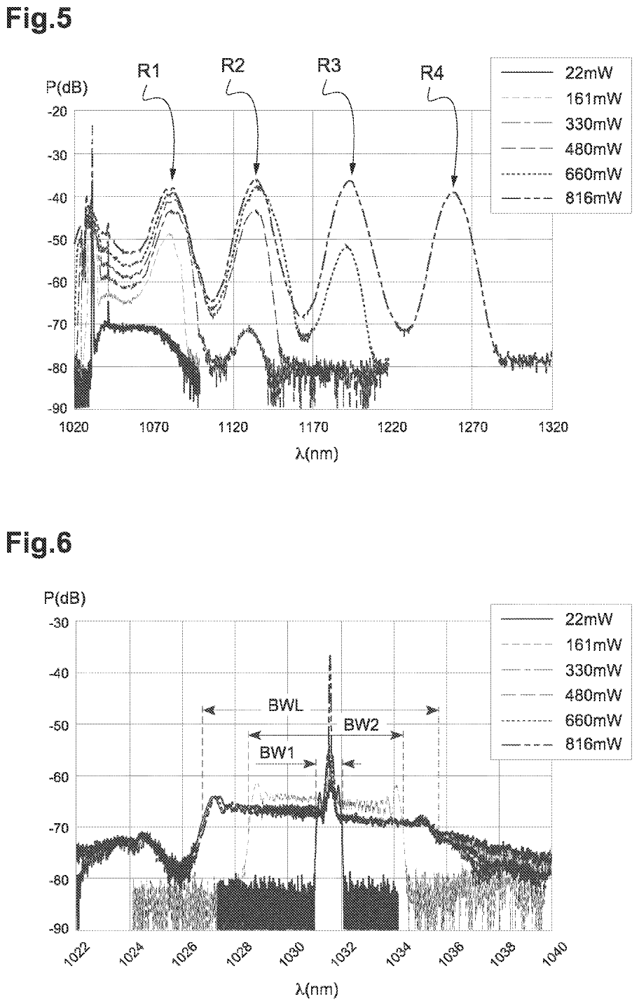

We describe more specifically the combined effects of Raman effect generation and spectral broadening by SPM in the passive optical fiber 61 in connection with FIGS. 5 and 6. The passive optical fiber 61 is here a silica fiber having a length of about 150 m.

FIG. 5 represents an example of spectral optical power measurements, as a function of the wavelength, the spectral optical power P being measured at the output of the passive optical fiber 61. The spectral optical power P is here measured for the same system of light pulse generation and for different average powers at the output of the optical amplification system 4. An increase in the power of the pump of the amplifier makes it possible to obtain an increase in the average power at the output. FIG. 6 shows the same measurements as FIG. 5 which are magnified around the center wavelength of the amplified pulse to more clearly show the spectral band broadening effect of SPM.

In this example, for an average power of 22 mW at the output of the optical amplification system 4, a maximum of the amplified pulse at the wavelength 1031 nm is observed in FIG. 5. In FIG. 6, the corresponding spectral width around the signal wavelength of 1031 nm is denoted BW1, and is less than 1 nm after broadening by SPM. With this average power of 22 mW, no Raman line is observed in the spectrum.

For an average power of 161 mW at the output of the optical amplification system 4, the maximum of the amplified pulse at the signal wavelength of 1031 nm is observed in FIG. 5 with a corresponding spectral width in FIG. 6, denoted BW2, of about 6 nm due to the SPM. We also observe in FIG. 5, for the average power of 161 mW, a first Raman line, denoted R1, around 1090 nm. The average power of 161 mW is in this example greater than a first spontaneous Raman generation threshold. This threshold depends in particular on the length of the passive optical fiber 61. In the present document, the first Raman line is also called the 1st order Raman line. It is observed that the first Raman line R1 is located outside the spectral band broadened by SPM around the signal wavelength. Moreover, the first Raman line R1 has a power about 20 dB lower than that of the pulse amplified around the signal wavelength and broadened by SPM.

For an average power of 330 mW at the output of the optical amplification system 4, the maximum of the amplified pulse at the wavelength 1031 nm is observed in FIG. 5 with a corresponding spectral width in FIG. 6, denoted BWL, of about 10 nm due to the SPM. We also observe in FIG. 5, for the average power of 330 mW, the first Raman line, denoted R1, around 1090 nm, and the appearance of a second Raman line, denoted R2, at approximately 1140 nm. In this example, the average power of 330 mW is greater than a second spontaneous Raman generation threshold. In this document, the second Raman line is also called the 2nd order Raman line. It is observed that the first Raman line R1 and the second Raman line R2 are located outside the spectral band broadened by SPM around the signal wavelength. Moreover, the first Raman line R1 and the second Raman line R2 have a power about 15-20 dB lower than that of the amplified pulse around the central wavelength and broadened by SPM.

For an average power of 480 mW, 660 mW or 816 mW respectively, at the output of the optical amplification system 4, FIG. 5 still shows the maximum of the amplified pulse at the wavelength 1031 nm with a constant spectral width, BWL, of about 10 nm related to the combined effects of the SPM and the spontaneous Raman effect generation of at least two Raman lines. Indeed, one also observes in FIG. 5, for the average power of 480 mW, 660 mW or respectively 816 mW, the first Raman line, R1, the second Raman line, R2. For the average powers of 660 mW and 816 mW, the appearance of a third Raman line, denoted R3, is observed at about 1195 nm. Finally, for the average power of 816 mW, the appearance of a fourth Raman line, denoted R4, is observed at about 1250 nm. However, it is observed in FIG. 6 that the spectral width of the amplified pulse at the wavelength 1031 nm remains constant from an average power of 330 mW on, which corresponds to the appearance of the second Raman line at about 1140 nm. The fact that this spectral width remains constant when the average power of the pulses varies from 330 mW to 816 mW, makes it possible to generate compressed pulses having a predetermined duration at the output of the compressor, limited by the spectral bandwidth BWL, while adjusting the power of these impulses. It is observed that the first Raman line R1, the second Raman line R2, the third Raman line R3 and the fourth Raman line R4 are all located outside the spectral band broadened by SPM around the signal wavelength. In addition, the first Raman line R1, the second Raman line R2, the third Raman line R3 and the fourth Raman line R4 each have a power about 10-15 dB lower than that of the amplified pulse around the central wavelength and broadened by SPM.

The combined effects of SPM generation and Raman effect generation in the passive optical fiber 61 thus make it possible to stabilize the characteristics of the compressed pulses at the output of the compressor and make it possible to adjust, independently, the duration of the compressed pulses and their power, in an operating range determined by a pulse duration range and a determined power range.

More specifically, the appearance of at least a first Raman line, and preferably a second Raman line and even more preferably a third Raman line and possibly a fourth Raman line, makes it possible to stabilize the energy of the amplified pulse spectrally broadened by self-phase modulation. In other words, the energy remains constant from one pulse to the next. A saturation of the spectral broadening is also observed with the appearance of the 1^{st}, 2^{nd}, 3^{rd} or 4^{th} order Raman lines.

For a passive fiber based on silica, each Raman line is separated in optical frequency of 13 THz.

The passive optical fiber 61 is chosen to have positive dispersion at the wavelength of the signal. In addition, the passive optical fiber 61 has a sufficient length to allow the generation of SPM effects and spontaneous Raman generation effects in the peak power range of the pulses received by the passive optical fiber 61.

Unlike other systems, the aim here is not to promote either SPM or Raman generation, but to combine and control these two effects to obtain compressed pulses that are stable over time, while being adjustable in duration and/or or in repetition rate via the electro-optical modulator.

A non-limiting interpretation of the phenomena illustrated in FIGS. 5-6 is as follows. With the increase in the peak power of the amplified pulses, the optical spectrum obtained by self-phase modulation contains more spectral components until the appearance of the Raman effect which transfers the energy of the pulses to create new wave lengths. Since the Raman effect appears for a peak power greater than that necessary for the generation of self-phase modulation, it is not harmful for obtaining femtosecond pulses. It is thus possible to saturate the phase self-modulation by reaching the threshold of appearance of the Raman effect so that the peak power variations of the pulses result in an evolution of the Raman gain inducing a drop in power in the Raman peaks while retaining the spectral components generated by SPM and while retaining the maximum energy in the spectral band broadened by SPM around the signal wavelength, and not in the Raman lines. The Raman lines are then filtered in the compressor.

The light pulse generation system according to the present disclosure makes it possible to generate on demand a pulse of adjustable duration in the sub-picosecond or femtosecond range. The light pulse generation system also makes it possible to generate a series of pulses, of adjustable duration in the sub-picosecond or femtosecond range, at the repetition frequency of the electro-optical modulator, these pulses being stable in energy over time. Finally, the light pulse generation system makes it possible to generate a pulse train, of adjustable duration in the sub-picosecond or femtosecond range, with intra-burst and inter-burst repetition frequencies determined by the electrical generator controlling the electro-optical modulator. The system according to the present disclosure makes it possible to stabilize the duration and the energy of the pulses in pulse train mode, within an adjustment range of the pulse duration and the peak power. In addition, the electric generator makes it possible to adjust the temporal shaping of the pulses.

The principle of the invention described above in connection with FIGS. 1, 5, 6 and 7 can be adapted according to different embodiments and/or variants.

FIG. 7 illustrates a variant of the first embodiment, based on a single-pass optical fiber amplifier system and a non-linear optical module at the output of the amplifier system. The same reference signs designate structural and/or functional elements common to the first embodiment described in connection with FIG. 1. The source 1 emits a source laser radiation 10. The electro-optical modulator 2 receives the continuous source laser radiation 10 and forms modulated light radiation comprising at least one source light pulse 20 at the signal wavelength. Optionally, an optical isolator 17 is placed between the output of the electro-optical modulator 2 and the optical amplification system 4. The optical amplification system 4 comprises at least one optical fiber amplifier 41 used in single pass. Another optical isolator 7 is arranged at the output of the optical amplification system 4. A passive optical fiber 61 is arranged to receive said at least one amplified light pulse 40 at the output of the optical isolator 7. At the output of the passive optical fiber 61, the amplified and spectrally broadened pulse 60 is transmitted to a compressor 8. At the output of the compressor, a compressed pulse 80 is obtained. The electro-optical modulator 2 allows easily to adjust the compressed pulse 80 in duration and/or in repetition frequency. The operation is similar to that described in connection with FIG. 1, except that the optical fiber amplifier is here used in single pass.

FIGS. 2 to 4 illustrate some of these embodiments and/or variants.

FIG. 2 represents a system for generating a light pulse of sub-picosecond duration according to a second embodiment. This system differs from that of FIG. 1 in that the passive optical fiber 61 is placed between the optical fiber amplifier 41 and the optical Bragg grating fiber spectral mirror 5. After the first pass through the optical fiber amplifier 41, the pulse amplified once is transmitted to the passive optical fiber 61. The system is here configured so that the peak power of the pulse amplified once is greater than the SPM generation and spontaneous Raman generation threshold during the first pass through the passive optical fiber 61. At the output of the passive optical fiber 61, the amplified and spectrally broadened pulse is filtered by the Bragg grating optical fiber 5, then returned in the direction of the passive optical fiber 61 for a second passage and then to the optical fiber amplifier 41 for a second amplification.

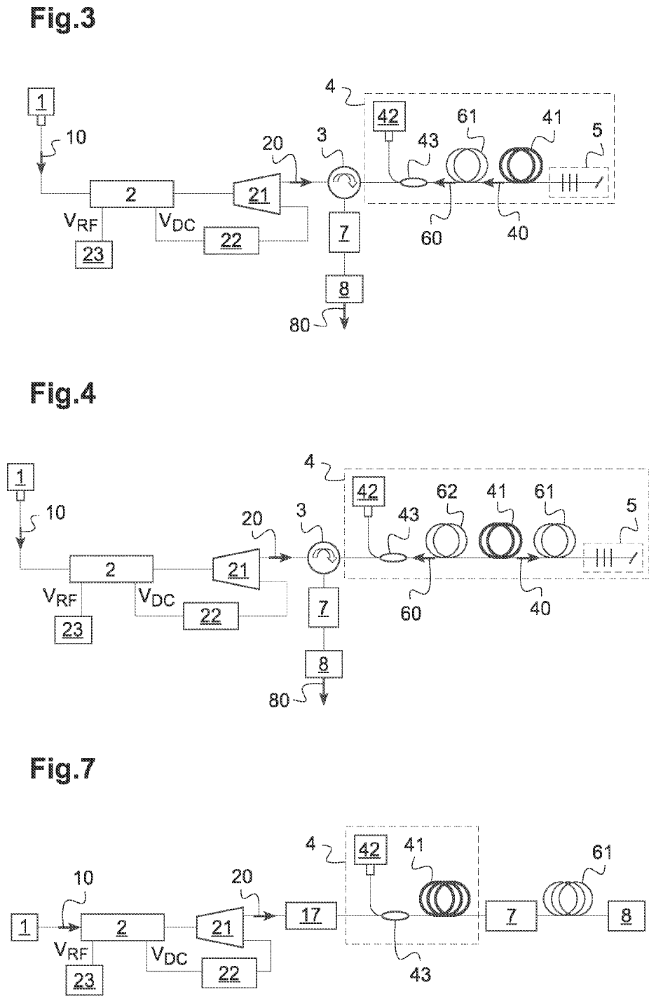

FIG. 3 represents a system for generating a light pulse of sub-picosecond duration according to a variant of the second embodiment. The passive optical fiber 61 is here also arranged inside the optical amplification system 4. This system differs from that of FIG. 2 in that the optical fiber amplifier 41 is arranged between the passive optical fiber 61 and the optical Bragg grating fiber spectral mirror 5. The modulated pulse 20 is transmitted by the passive optical fiber 61 in the direction of the optical amplifier 41. After a first passage in the optical fiber amplifier 41, the amplified pulse once is transmitted to the optical Bragg grating fiber 5 and then reflected towards the optical fiber amplifier 41 for a second amplification. The twice amplified pulse is then transmitted to the passive optical fiber 61 in the return direction. The system is here configured so that the peak power of the twice amplified pulse is greater than the SPM generation and spontaneous Raman generation threshold during the second passage through the passive optical fiber 61. At the output of the passive optical fiber 61, the amplified and spectrally broadened pulse 60 is transmitted via the optical circulator 3 to the optical isolator 7 and then to the compressor 8.

FIG. 4 represents a system for generating a light pulse of sub-picosecond duration according to a variant combining the first and the second embodiment. The system here comprises a first passive optical fiber 61 and a second passive optical fiber 62. The first passive optical fiber 61 and the second passive optical fiber 62 are arranged inside the optical amplification system 4. The optical fiber amplifier 41 is placed between the first passive optical fiber 61 and the second passive optical fiber 62. The first passive optical fiber 61 is placed between the pump combiner 43 and the optical fiber amplifier 41. The second passive optical fiber 62 is placed between the optical fiber amplifier 41 and the optical Bragg grating fiber spectral mirror 5. The modulated pulse 20 is transmitted by the first passive optical fiber 61 in the direction of the optical amplifier 41. After a first passage in the optical fiber amplifier 41, the once amplified pulse is transmitted to the second passive optical fiber 62. The system is here configured so that the peak power of the once amplified pulse is greater than the threshold for generating SPM and spontaneous Raman generation during the first pass through the second passive optical fiber 62. At the output of the second passive optical fiber 62, the amplified and spectrally broadened pulse is filtered by the Bragg grating optical fiber 5, then returned in the direction of the second passive optical fiber 62 in the return direction and then towards the optical fiber amplifier 41 for a second amplification. The twice amplified pulse is then transmitted to the first passive optical fiber 61 in the return direction. The system is here configured so that the peak power of the twice amplified pulse is greater than the SPM generation and spontaneous Raman generation threshold during the second passage through the first passive optical fiber 61. At the output of the first passive optical fiber 61, the amplified and spectrally broadened pulse 60 is transmitted via optical circulator 3 to optical isolator 7 and then to compressor 8.

The present disclosure finds applications in the use of light pulses having a duration in the range between one and a few hundred femtoseconds (fs) or from one to ten picoseconds in the scientific, industrial or medical field. In particular, the invention finds applications in cosmetics or dermatology for hair removal.

Of course, various other modifications may be made to the invention within the scope of the appended claims.

1. System for generating at least one light pulse, said at least one light pulse being adjustable in duration and/or in repetition frequency, the system comprising:
a source of source laser radiation,
an electro-optical modulator, the electro-optical modulator being adapted to receive the source laser radiation and to form at least one source light pulse having a duration of less than or equal to 100 picoseconds, the electro-optical modulator being adapted to adjust said at least one source light pulse in duration and/or in repetition frequency;
an optical amplification system comprising an optical amplifier operating in the abnormal dispersion regime, the optical amplification system being adapted to receive said at least one source light pulse and to form at least one amplified light pulse,
a passive optical fiber arranged to receive said at least one amplified light pulse and generate at least one spectrally broadened amplified light pulse, the amplified light pulse having a peak power greater than a threshold determined to spectrally broaden said at least one amplified light pulse by self-phase modulation in the passive optical fiber and to generate a non-linear Raman signal, the non-linear Raman signal being adapted to stabilize in energy said at least one spectrally broadened amplified light pulse, and
a compressor arranged to receive at least one spectrally broadened amplified light pulse and to generate at least one compressed pulse, adjustable in duration and/or in repetition frequency by means of the electro-optical modulator.

2. The system according to claim 1, in which the electro-optical modulator is adapted to form a packet of N source light pulses, N being an integer comprised between 100 and 10,000, the packet being repeated at a frequency comprised between 1 MHz and 100 MHz.

3. The system according to claim 1, in which the optical amplification system comprises a Bragg grating fiber forming a spectrally selective mirror, the Bragg grating fiber being arranged to receive at least one light pulse amplified a first time by the optical amplifier and to return said amplified light pulse to the optical amplifier for a second amplification.

4. The system according to claim 3, in which the passive optical fiber is arranged between the optical amplifier and the Bragg grating fiber.

5. The system according to claim 3, in which the optical amplifier is arranged between the passive optical fiber and the Bragg grating fiber.

6. The system according to claim 5, comprising another passive optical fiber arranged between the optical amplifier and the Bragg grating fiber.

7. The system according to claim 1, in which the optical amplifier comprises an optical fiber amplifier doped with erbium, ytterbium, thulium, holmium or neodymium and/or an amplifier with crystals or glass doped with ytterbium or neodymium.

8. The system according to claim 1, in which the passive optical fiber is based on silica glass or fluoride glass.

9. The system according to claim 1, comprising an electric generator adapted to apply a modulated electric signal to the electro-optical modulator, the modulated electric signal being adapted to temporally shape said at least one source light pulse.

10. The system according to claim 8, in which the electro-optical modulator is a Mach-Zehnder type amplitude modulator, the system for generating at least one light pulse of sub-picosecond duration comprising a servo-control system with feedback loop of the electro-optical modulator.

11. Method for generating at least one light pulse of sub-picosecond duration, said at least one light pulse being adjustable in duration and/or in repetition frequency, the method comprising the following steps:
generation of source laser radiation,
modulation of the source laser radiation by means of an electro-optical modulator adapted to form at least one source light pulse and to adjust said at least one source light pulse in duration and/or in repetition frequency;
optical amplification of said at least one source light pulse in an optical amplifier operating in the abnormal dispersion regime, to form at least one amplified light pulse,
transmission of said at least one amplified light pulse in a passive optical fiber, the amplified light pulse having a peak power greater than a determined threshold to generate at least one spectrally broadened amplified light pulse by self-phase modulation and to simultaneously generate a non-linear Raman signal, and
compression of said at least one spectrally broadened amplified light pulse to generate at least one compressed pulse, adjustable in duration and/or in repetition frequency by means of the electro-optical modulator.
